(19) United States
(12) Patent Application Publication
(10) Pub. No.: US 2025/0082450 A1
(43) Pub. Date: Mar. 13, 2025

(54) PHOTO-CURING OPERATION PORTION AND DENTAL PHOTO-CURING MACHINE

(71) Applicant: GUILIN WOODPECKER MEDICAL INSTRUMENT CO., LTD., Guilin (CN)

(72) Inventors: Xunxian WU, Guilin (CN); Yuancheng WEI, Guilin (CN); Jiabing XU, Guilin (CN); Hai ZHONG, Guilin (CN); Haoran CHEN, Guilin (CN); Shuangji WANG, Guilin (CN)

(21) Appl. No.: 18/940,509

(22) Filed: Nov. 7, 2024

(30) Foreign Application Priority Data
Sep. 8, 2023 (CN) 2023224489372
Oct. 25, 2024 (CN) 202422594806X

(51) Int. Cl. A61C 13/15; B29C 35/08

(52) U.S. Cl. CPC A61C 19/004; B29C 35/0805

(57) ABSTRACT

A photo-curing operation portion and a photo-curing machine are provided. The photo-curing operation portion includes: a shell, having a first end as a lamp mounting end, and a second end as a host mounting end for being mounted to a host; a photo-curing lamp, provided at the lamp mounting end, wherein the shell is provided with a mounting cavity configured to arrange wire(s) of the photo-curing lamp; and a thermally insulated structure, wherein the thermally insulated structure is provided between a thermally conductive plate of the photo-curing lamp and an inner wall of the shell.

### CROSS-REFERENCE TO RELATED APPLICATIONS

The present disclosure claims the priority to the Chinese patent application with the filing No. 2023224489372 filed on Sep. 8, 2023 with the Chinese Patent Office and entitled “PHOTO-CURING OPERATION PORTION AND PHOTO-CURING MACHINE”, and the Chinese patent application with the filing No. 202422594806X filed on Oct. 25, 2024 with the Chinese Patent Office and entitled “HEAT DISSIPATION MECANISM AND DENTAL PHOTO-CURING MACHINE”, the contents of which are incorporated herein by reference in entirety.

### TECHNICAL FIELD

The present disclosure relates to the technical field of oral medical instruments, in particular to a photo-curing operation portion and a dental photo-curing machine.

### BACKGROUND ART

The photo-curing machine, which is an oral device for repairing teeth, utilizes the photo-curing principle to make dental repairing resin materials quickly cured under effect of light waves within a specific wavelength range, so as to fill tooth cavities or bond brackets, and implement treatments of repairing teeth, etc.

The photo-curing machine typically includes a host and a photo-curing operation portion detachably provided on the host, where a main operation element of the photo-curing operation portion is a photo-curing lamp, which usually generates heat while emitting light during operation. Conventional photo-curing lamps have a weak light intensity or a single light source (blue light) and generate a small amount of heat, and good heat dissipation generally can be achieved by mounting into a shell a thermally conductive plate on a back portion of the photo-curing lamp.

However, for the photo-curing operation portion with a small shape, a compact structure and a high light intensity, good heat dissipation can hardly be achieved according to the conventional method, leading to a high local temperature in the vicinity of the photo-curing lamp, which, on the one hand, affects light emitting efficiency and service lifetime of the photo-curing lamp, and on the other hand, may cause a patient to be scalded as the photo-curing lamp often operates in an oral cavity of the patient.

Therefore, a technical problem currently to be solved by those skilled in the art is how to avoid the problem of scalding a patient due to a too high temperature of a part of the photo-curing operation portion located in the oral cavity of the patient.

### SUMMARY

Embodiments of the present disclosure disclose a photo-curing operation portion, including:
a shell, having a first end as a lamp mounting end, and a second end as a host mounting end configured for being mounted to a host;
a photo-curing lamp, provided at the lamp mounting end, where the shell is provided with a mounting cavity configured to arrange at least one wire of the photo-curing lamp; and
a thermally insulated structure, where the thermally insulated structure is provided between the thermally conductive plate of the photo-curing lamp and an inner wall of the shell.

In one or more embodiments, the thermally insulated structure includes a thermally insulated cavity provided between the thermally conductive plate of the photo-curing lamp and the inner wall of the shell; and/or
the thermally insulated structure includes a thermally insulated pad provided on the thermally conductive plate of the photo-curing lamp.

In one or more embodiments, the above photo-curing operation portion further includes a thermally conductive wrapping provided between the thermally insulated pad and the thermally conductive plate, where the thermally conductive wrapping extends into the mounting cavity.

In one or more embodiments, a part of the thermally conductive wrapping located in the mounting cavity wraps an outer side of the at least one wire.

In one or more embodiments, a heat storage material configured for absorbing heat of the thermally conductive wrapping is filled in the mounting cavity.

In one or more embodiments, the thermally conductive wrapping passes through the heat storage material.

In one or more embodiments, the heat storage material is a phase-change heat storage material; and/or the thermally conductive wrapping is made of graphene or metal.

In one or more embodiments, the heat storage material is phase-change paraffin or phase-change microcapsule, and in the mounting cavity, thermally conductive adhesive layers are provided at two sides of the heat storage material, a heat storage cavity is formed between the thermally conductive adhesive layers, and the heat storage material is located in the heat storage cavity;
alternatively, the heat storage material is a heat storage gel.

In one or more embodiments, the lamp mounting end is provided with a light outlet, the photo-curing lamp is provided in a cavity of the lamp mounting end, a light emitting portion of the photo-curing lamp faces the light outlet, and a lens is fixed at the light outlet by a locking element.

In one or more embodiments, the above photo-curing operation portion further includes a heat dissipation mechanism, where the heat dissipation mechanism includes the shell and a thermally conductive assembly, an inner cavity of the shell includes the lamp mounting end and a main body portion communicating with each other, the lamp mounting end is configured to mount the photo-curing lamp; the thermally conductive assembly includes the thermally conductive plate and a heat pipe located on at least one side of the thermally conductive plate, the thermally conductive plate partially extends into the lamp mounting end, so as to be capable of being closely attached to the photo-curing lamp, and the other end of the thermally conductive plate extends into the main body portion, so as to conduct heat generated by the photo-curing lamp to a part of the shell for forming the main body portion.

In one or more embodiments, the thermally conductive plate is a copper plate, and two opposite sides of the thermally conductive plate are respectively provided with the heat pipe.

In one or more embodiments, the main body portion is filled therein with a heat storage material, and the thermally conductive plate and the heat pipe are both wrapped by the heat storage material.

In one or more embodiments, the heat storage material includes a phase-change material.

In one or more embodiments, the thermally conductive plate divides the lamp mounting end into a mounting cavity and a thermally insulated cavity, where the mounting cavity is configured to mount the photo-curing lamp, the thermally insulated cavity communicates with the main body portion, and one side of the thermally conductive plate facing the mounting cavity is closely attached to the photo-curing lamp.

In one or more embodiments, the lamp mounting end has a mounting hole located between the mounting cavity and the thermally insulated cavity, and the thermally conductive plate has a mounting protrusion, where the mounting protrusion fits in the mounting hole, and one side of the mounting protrusion facing the mounting cavity is closely attached to the photo-curing lamp.

In one or more embodiments, a thermally insulated pad is closely attached to a side of the thermally conductive plate facing back to the mounting cavity, and the thermally insulated pad is spaced apart from a region of an inner wall of the thermally insulated cavity away from the mounting cavity.

In one or more embodiments, the heat pipe is provided between the thermally insulated pad and the thermally conductive plate.

In one or more embodiments, the above photo-curing operation portion further includes a lens, where the lens is embedded at the lamp mounting end and is corresponding to a light emergent side of the photo-curing lamp.

Embodiments of the present disclosure further provide a dental photo-curing machine, including the photo-curing operation portion in the preceding embodiments.

### BRIEF DESCRIPTION OF DRAWINGS

In order to more clearly illustrate technical solutions in embodiments of the present disclosure or in the prior art, drawings that need to be used in the description of the embodiments or the prior art will be briefly introduced below. Apparently, the drawings in the following description merely show some embodiments of the present disclosure, and those ordinarily skilled in the art also could obtain other drawings in light of these drawings without using any inventive efforts.

FIG. 1 is a structural schematic view of a photo-curing operation portion disclosed in embodiments of the present disclosure;

FIG. 2 is a sectional view of a photo-curing operation portion disclosed in embodiments of the present disclosure;

FIG. 3 is a partial sectional view of a photo-curing operation portion disclosed in embodiments of the present disclosure;

FIG. 4 is a structural schematic view of a thermally conductive wrapping wrapping wires disclosed in embodiments of the present disclosure;

FIG. 5 is a schematic view of internal structures of a dental photo-curing machine disclosed in embodiments of the present disclosure; and

FIG. 6 is a partial structural schematic view of FIG. 5.

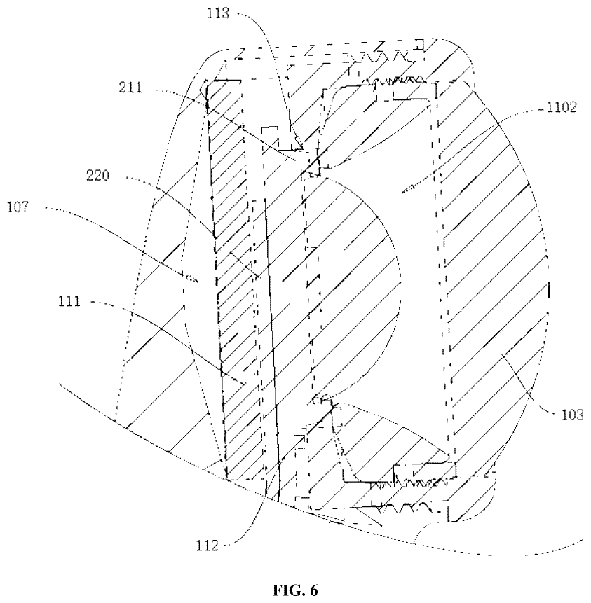

Reference signs: 101—shell; 1101—lamp mounting end; 107—thermally insulated cavity; 1102—mounting cavity; 113—mounting hole; 120—main body portion; 200—thermally conductive assembly; 112—thermally conductive plate; 211—mounting protrusion; 220—heat pipe; 108—photo-curing lamp; 103—lens; 111—thermally insulated pad; 110—heat storage material; 102—adapter shaft; 104—wire; 105—circuit board; 106—thermally conductive wrapping; 107—thermally insulated cavity; 108—photo—curing lamp; 109-locking element.

### DETAILED DESCRIPTION OF EMBODIMENTS

In order to make objectives, technical solutions and advantages of embodiments of the present disclosure clearer, the technical solutions in the embodiments of the present disclosure will be clearly and completely described in conjunction with the drawings in the embodiments of the present disclosure, and apparently, only some but not all embodiments are described. Generally, components of the embodiments of the present disclosure described and illustrated in drawings herein may be arranged and designed in a variety of different configurations. Therefore, the detailed description below of the embodiments of the present disclosure provided in the drawings is not intended to limit the scope of protection of the present disclosure, but merely represents chosen embodiments of the present disclosure. Based on the embodiments in the present disclosure, all of other embodiments obtained by those ordinarily skilled in the art without using any inventive efforts shall fall within the scope of protection of the present disclosure.

It should be noted that various embodiments in the present description are described in a progressive manner, where each embodiment focuses on differences from other embodiments, and the same or similar parts between various embodiments may be referred to each other.

It should be noted that like reference signs and letters represent like items in the following drawings, and thus, once a certain item is defined in one drawing, it is unnecessary to further define and explain the same in subsequent drawings.

As used in the present disclosure and the claims, unless the exceptions clearly indicated in the context, terms “a (an)”, “one” and/or “the” do not specifically refer to the singular, but may also include the plural. In general, the terms “include” and “contain” merely prompt the inclusion of steps and elements that have been explicitly identified, and such steps and elements do not constitute an exclusive list, and other steps or elements may be encompassed by methods or devices. An element specified by the wordings “including a . . . ” does not exclude the presence of additional identical elements in a process, method, article or device that includes the specified element.

In the description of the present disclosure, it should be noted that orientation or positional relationships indicated by the terms such as “center”, “up”, “down”, “left”, “right”, “vertical”, “horizontal”, “inside”, and “outside” are based on the orientation or positional relationships shown in the drawings, or orientation or positional relationships in which the product of the present disclosure is placed conventionally in use, only for facilitating describing the present disclosure and simplifying the description, rather than indicating or implying that the referred devices or elements must be in a particular orientation or constructed or operated in the particular orientation, and therefore they should not be construed as limitation to the present disclosure. In addition, the terms such as “horizontal”, “vertical”, and “overhanging” do not mean that the component is required to be absolutely horizontal or overhanging, but may be slightly inclined. For example, by “horizontal” it merely means that a structure is more horizontal in comparison with “vertical”, rather than being completely horizontal, while the structure may be slightly inclined.

In addition, the terms such as “first”, “second”, and “third” are used for descriptive purpose only, but should not be construed as an indication or implication of importance in relativity or an implicit indication of the number of the referred technical features. Thus, defining a feature with “first” or “second” may explicitly or implicitly mean that one or more such features are included.

In the description of the present disclosure, it should be further noted that, unless otherwise specifically specified and defined, the terms “provide”, “mount”, “link”, and “connect” should be understood in a broad sense, for example, a connection may be a fixed connection, a detachable connection, or an integrated connection; it may be a mechanical connection or an electrical connection; it may be direct linking or indirect linking through an intermediary, and it also may be inner communication between two elements. For those ordinarily skilled in the art, specific meanings of the above-mentioned terms in the present disclosure could be understood according to specific circumstances.

Some embodiments of the present disclosure will be described in detail below in conjunction with the drawings. The following embodiments and features in the embodiments may be combined with each other without conflict.

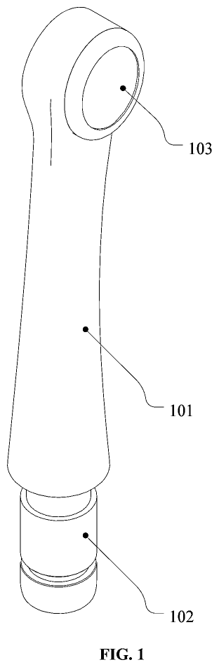

As shown in FIG. 1, embodiments of the present disclosure disclose a photo-curing operation portion. The photo-curing operation portion is a main functional component of a photo-curing machine. The photo-curing operation portion is detachably provided on a host of the photo-curing machine. A battery is typically provided in the host. The host is configured to provide power for the photo-curing operation portion.

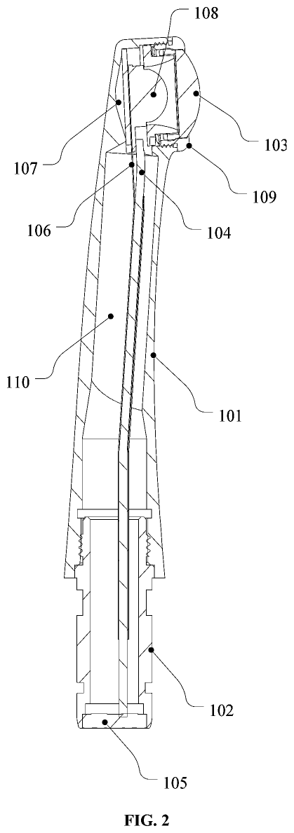

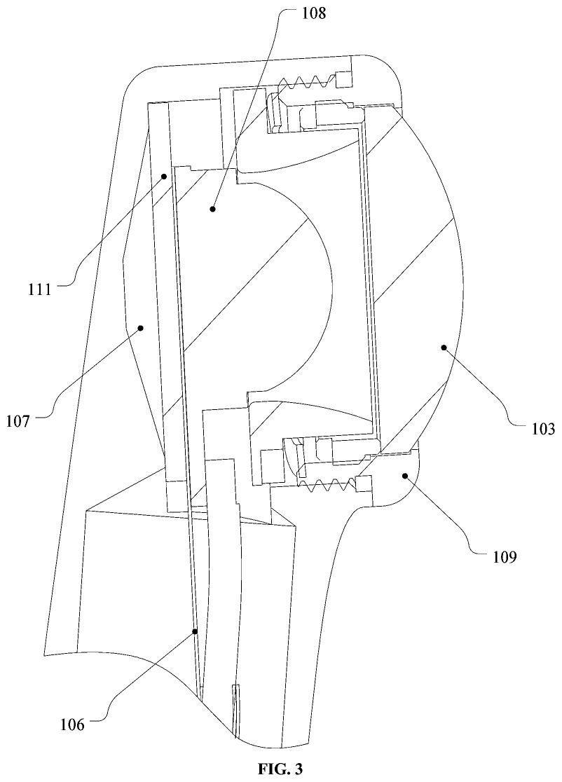

In one or more embodiments, as shown in FIG. 2 and FIG. 3, the photo-curing operation portion includes a shell (metal housing) 101, a photo-curing lamp 108 and a thermally insulated structure. The shell 101 is a main supporting part of the photo-curing operation portion, and has a first end that is a lamp mounting end (also referred to as a head portion) for mounting the photo-curing lamp 108, and a second end that is a host mounting end for being mounted to the host. An adapter shaft 102 is usually provided at the host mounting end, and by inserting the adapter shaft 102 into an end socket of the host, a detachable connection between the photo-curing operation portion and the host is realized.

In one or more embodiments, the photo-curing lamp 108 is provided at the lamp mounting end. The shell 101 has a mounting cavity for arranging wire(s) 104 of the photo-curing lamp 108. The shell 101 is in a hollow-structure state. The wire(s) 104 of the photo-curing lamp 108 pass(es) through the mounting cavity from one end (the lamp mounting end) of the shell 101, and extends towards the other end (the host mounting end). An adapter circuit board 105 is usually provided at an end portion of the adapter shaft 102. The wire(s) 104 of the photo-curing lamp 108 extend(s) to a position of the adapter circuit board 105 and is electrically connected to the adapter circuit board 105. One end of the adapter shaft 102 is usually provided as a threaded portion, the adapter circuit board 105 is provided at the other end of the adapter shaft 102, and the adapter shaft 102 is in threaded connection with the host mounting end of the shell 101 through the threaded portion. After the photo-curing operation portion is inserted into the host of the photo-curing machine through the adapter shaft 102, the photo-curing lamp 108 realizes electrical connection with the host through the wire(s) 104 and the adapter circuit board 105, so that the battery in the host can supply power to the photo-curing lamp 108 and other elements.

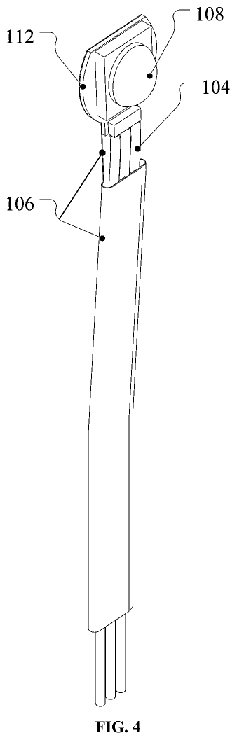

In one or more embodiments, as shown in FIG. 4, the thermally insulated structure is provided between a thermally conductive plate (base plate) 112 of the photo-curing lamp 108 and an inner wall of the shell 101. Specifically, the thermally insulated structure may be a thermally insulated cavity 107 or a thermally insulated pad 111, or include both the thermally insulated cavity 107 and the thermally insulated pad 111. Introduction is given below by taking a case that both the thermally insulated cavity 107 and the thermally insulated pad 111 are included as an example.

In one or more embodiments, the thermally insulated pad 111 is provided on the thermally conductive plate 112 of the photo-curing lamp 108. The thermally insulated pad 111 may be directly fixed on the thermally conductive plate 112 of the photo-curing lamp 108, or may be indirectly provided on the thermally conductive plate 112 of the photo-curing lamp 108 through other components. The thermally insulated cavity 107 is formed between the thermally insulated pad 111 and the inner wall of the shell 101, that is, the inner wall of the shell 101 is provided, at a position where the thermally insulated pad 111 is provided, with the thermally insulated cavity 107 recessed in a direction away from the thermally insulated pad 111, so as to ensure a larger distance between the thermally conductive plate 112 of the photo-curing lamp 108 and corresponding inner wall of the shell 101, thereby reducing heat conduction efficiency.

To sum up, for the photo-curing operation portion provided by the present disclosure, the thermally insulated pad 111 is provided on the thermally conductive plate 112 of the photo-curing lamp 108, and the thermally insulated pad 111 is closer to the inner wall of the shell 101 than the thermally conductive plate 112; therefore, under effect of the thermally insulated pad 111, a speed at which heat of the thermally conductive plate 112 is conducted to the shell 101 can be reduced. At the same time, the thermally insulated cavity 107 is further provided between the thermally insulated pad 111 and the inner wall of the shell 101, and compared with a case that the thermally insulated pad 111 is directly attached to the inner wall of the shell 101, presence of the thermally insulated cavity 107 renders lower heat transfer efficiency. Under dual thermal insulation effect of the thermally insulated pad 111 and the thermally insulated cavity 107, a speed at which heat of the photo-curing lamp 108 is conducted to the shell 101 in the vicinity of the photo-curing lamp 108 can be slowed down, thus preventing a too high local temperature of the shell 101 located in the oral cavity, and avoiding scalding the patient.

In the above embodiments, although the solution in which the thermally insulated pad 111 and the thermally insulated cavity 107 are added can prevent, to a certain extent, a too high local temperature of the shell 101 and reduce risks of scalding the patient, the heat is still aggregated in the vicinity of the photo-curing lamp 108, and as turn-on time (i.e., the duration that the photo-curing lamp keeps working) of the photo-curing lamp 108 increases, a temperature of the shell 101 also rises continuously, and thus medical personnel need to turn off the photo-curing machine after a period of time of usage, which undoubtedly affects use efficiency of the photo-curing machine.

Based on this, in one or more embodiments, the present disclosure adds to the photo-curing operation portion a thermally conductive wrapping 106 for conducting heat out. The thermally conductive wrapping 106 is provided between the thermally insulated pad 111 and the thermally conductive plate 112, that is, the thermally conductive wrapping 106 is attached onto the thermally conductive plate 112, and the thermally insulated pad 111 is attached onto the thermally conductive wrapping 106. The thermally conductive wrapping 106 extends into the mounting cavity. In order to ensure better heat dissipation efficiency, an area of the thermally conductive wrapping 106 is as large as possible. The heat of the thermally conductive plate 112 is transferred to the entire thermally conductive wrapping 106 through a part thereof in contact with the thermally conductive wrapping 106, and is transferred into the mounting cavity under effect of the thermally conductive wrapping 106. As a part of the heat of the thermally conductive plate 112 is absorbed and transferred by the thermally conductive wrapping 106, the heat remaining in the vicinity of the photo-curing lamp 108 is reduced to some extent, heat of the shell 101 in the vicinity of the photo-curing lamp 108 is subsequently reduced to some extent; even with the increase of the turn-on time, the heat will not increase sharply, thus avoiding scalding the patient; and at the same time, as the heat in the vicinity of the photo-curing lamp 108 is reduced, it is also conducive to prolonging the service lifetime of the photo-curing lamp 108.

In one or more embodiments, the thermally conductive wrapping 106 may use graphene or metal (red copper, aluminum, etc.) as a thermally conductive material. The present disclosure does not limit the thermally conductive material, any material with a high thermal conductivity coefficient may be used, and especially materials with a good heat conduction effect in a horizontal direction are more suitable as materials of the thermally conductive wrapping 106.

In one or more embodiments, a part of the thermally conductive wrapping 106 located in the mounting cavity wraps an outer side of the wire 104. In the present embodiment, the thermally conductive wrapping 106 and the wire(s) 104 are fixed together in a wrapping manner, so that an extending direction and a position of the wire(s) 104 can be constrained by virtue of a rigid characteristic of the thermally conductive wrapping 106, thereby avoiding electrical disconnection caused by movement of the wire(s) 104. A plurality of wires 104 are usually provided, the thermally conductive wrapping 106 can simultaneously wrap the plurality of wires 104, or each wire 104 can be wrapped by one thermally conductive wrapping 106. The present disclosure does not limit a form of the thermally conductive wrapping 106.

In one or more embodiments, the thermally conductive wrapping 106 is located in the mounting cavity and may not be in contact with the inner wall of the shell 101, so as to reduce efficiency of heat conduction of the thermally conductive wrapping 106 to the shell 101, and avoid rapid increase of the temperature of the shell 101. The thermally conductive wrapping 106 is located in the mounting cavity and may also be connected to the shell 101 through some thermally conductive fins, so as to conduct heat of the thermally conductive wrapping 106 to the shell 101, and dissipate the heat into air through the shell 101, where the thermally conductive fins are located as far away as possible from the part located in the oral cavity.

In order to prevent a too high temperature of the shell 101 while satisfying heat dissipation, in the present embodiment, a heat storage material 110 for absorbing the heat of the thermally conductive wrapping 106 is filled in the mounting cavity. The heat storage material 110 may be a phase-change heat storage material, for example, a phase-change heat storage material such as phase-change paraffin or phase-change microcapsule, or a mixture of a phase-change material such as phase-change paraffin and a thermally conductive material. The thermally conductive wrapping 106 transfers the heat of the photo-curing lamp 108 at the thermally conductive plate 112 in an extending direction thereof to the mounting cavity, in which process, the heat is radiated/conducted to the shell 101 to be dissipated; and then the heat storage material 110 formed of a heat storage material is filled in the mounting cavity, so that the heat that fails to be timely dissipated by the shell 101 is absorbed and stored by the heat storage material 110 under high heat generation conditions, and after the photo-curing machine stops operation, the stored heat is slowly released by the heat storage material 110 to the shell 101, and dissipated into surrounding environment through the shell 101.

In order to ensure that more heat that cannot be timely dissipated by the thermally conductive wrapping 106 can be absorbed and stored by the heat storage material 110, in the present embodiment, the thermally conductive wrapping 106 passes through the heat storage material 110, that is, the heat storage material 110 wraps a part of the thermally conductive wrapping 106, so as to improve heat conduction efficiency, and make the heat of the thermally conductive wrapping 106 absorbed by the heat storage material 110.

Since the heat storage material 110 is made of a phase-change material, a volume thereof may change with temperature, and at same time, the heat storage material 110 also has certain fluidity as the temperature rises. In order to prevent leakage caused by volume expansion of the heat storage material 110 in a high-temperature environment, a thermally conductive adhesive layer (not shown in the drawings) is added in the present embodiment. The thermally conductive adhesive layer is provided in the mounting cavity and located at two sides of the heat storage material 110, so that a heat storage cavity is formed between thermally conductive adhesive layers at the two sides of the heat storage material 110, and the heat storage material 110 is located in the heat storage cavity. It should be noted that the heat storage material 110 may also be made of a heat storage gel, and in this way, leakage of the heat storage material 110 can also be avoided without providing the thermally conductive adhesive layer.

Since the volume of the heat storage material 110 may increase as temperature rises, in order to ensure that the heat storage cavity can accommodate the heat storage material 110 after the temperature rises, a sufficient volume needs to be ensured for the heat storage cavity. In the present embodiment, the heat storage material 110 is isolated in the heat storage cavity through the thermally conductive adhesive layer, so that the heat storage material 110 can be prevented from leaking or entering into vicinity of the photo-curing lamp 108 to affect normal operation of the photo-curing lamp 108. In addition, there may be a bare conductor at a connection part of the wire 104 and the thermally conductive plate 112 of the photo-curing lamp 108, and the thermally conductive adhesive layer can also improve an insulation effect at the connection part of the wire 104, thereby preventing short circuit.

In one or more embodiments, as shown in FIG. 2, the lamp mounting end is provided with a light outlet, the photo-curing lamp 108 is provided in a cavity of the lamp mounting end, a light emitting portion of the photo-curing lamp 108 faces the light outlet, and a lens 103 is fixed at the light outlet by a locking element 109. The lens 103 gathers light emitted by the photo-curing lamp 108, so that use effect is better. The locking element 109 is configured to fix components such as the lens 103 and the photo-curing lamp 108.

In the photo-curing operation portion of the above embodiments of the present disclosure, the thermally insulated structure is provided on the base plate of the photo-curing lamp, and the thermally insulated structure can isolate the base plate from the inner wall of the metal housing; therefore, under the effect of the thermally insulated structure, a speed at which the heat of the base plate is conducted to the metal housing can be slowed down. The speed at which the heat of the photo-curing lamp is conducted to the metal housing in the vicinity of the photo-curing lamp can be slowed down, thus preventing a too high local temperature of the metal housing located in the oral cavity, and avoiding scalding the patient.

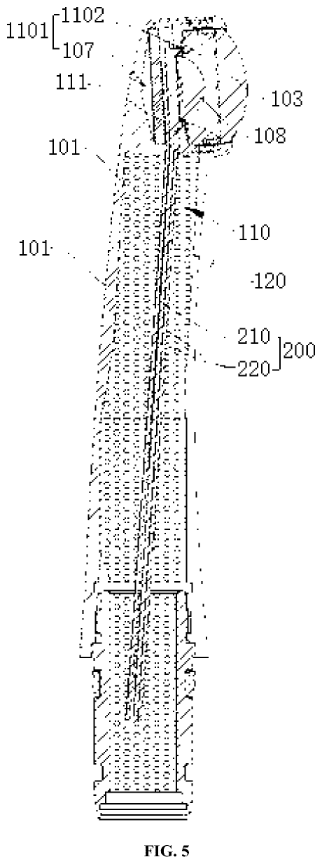

In one or more embodiments, further as shown in FIG. 4 and FIG. 5, the photo-curing operation portion in the present disclosure further includes a heat dissipation mechanism. The heat dissipation mechanism includes the shell 101 and a thermally conductive assembly 200. An inner cavity of the shell 101 includes a lamp mounting end (i.e., a head portion) 1101 and a main body portion 120 which communicate with each other. The lamp mounting end 1101 is configured to mount the photo-curing lamp 108. The thermally conductive assembly 200 includes a thermally conductive plate (base plate) 112 and a heat pipe 220 located on at least one side of the thermally conductive plate 112. The thermally conductive plate 112 partially extends into the lamp mounting end 1101, so as to be capable of being closely attached to the photo-curing lamp 108, and the other end of the thermally conductive plate 112 extends into the main body portion 120, so as to conduct heat generated by the photo-curing lamp 108 to a part of the shell 101 for forming the main body portion 120.

In one or more embodiments, the thermally conductive plate 112 is a copper plate, and two opposite sides of the thermally conductive plate 112 are respectively provided with the heat pipe 220.

In one or more embodiments, the main body portion 120 is filled therein with a heat storage material 110, and the thermally conductive plate 112 and the heat pipe 220 are both wrapped by the heat storage material 110.

In one or more embodiments, the heat storage material 110 includes a phase-change material.

In one or more embodiments, the thermally conductive plate 112 divides the lamp mounting end 1101 into a mounting cavity 1102 and a thermally insulated cavity 107, where the mounting cavity 1102 is configured to mount the photo-curing lamp 108, the thermally insulated cavity 107 communicates with the main body portion 120, and one side of the thermally conductive plate 112 facing the mounting cavity 1102 is closely attached to the photo-curing lamp.

In one or more embodiments, the lamp mounting end 1101 has a mounting hole 113 located between the mounting cavity and the thermally insulated cavity 107. The thermally conductive plate 112 has a mounting protrusion 211, where the mounting protrusion 211 fits in the mounting hole 113, and one side of the mounting protrusion 211 facing the mounting cavity 1102 is closely attached to the photo-curing lamp 108.

In one or more embodiments, a thermally insulated pad 111 is closely attached to a side of the thermally conductive plate 112 facing back to the mounting cavity 1102, and the thermally insulated pad 111 is spaced apart from a region of an inner wall of the thermally insulated cavity 107 away from the mounting cavity 1102.

In one or more embodiments, the heat pipe 220 is provided between the thermally insulated pad 111 and the thermally conductive plate 112.

In one or more embodiments, the above photo-curing operation portion further includes a lens 103, where the lens 103 is embedded at the lamp mounting end 1101 and is corresponding to a light emergent side of the photo-curing lamp 108.

In the photo-curing operation portion disclosed in the above embodiments of the present disclosure, the thermally insulated structure is provided on the base plate of the photo-curing lamp, and the thermally insulated structure can isolate the base plate from the inner wall of the metal housing; therefore, under the effect of the thermally insulated structure, a speed at which the heat of the base plate is conducted to the metal housing can be slowed down. The speed at which the heat of the photo-curing lamp is conducted to the metal housing in the vicinity of the photo-curing lamp can be slowed down, thus preventing a too high local temperature of the metal housing located in the oral cavity, and avoiding scalding the patient.

The photo-curing operation portion disclosed in the above embodiments of the present disclosure is mounted therein with a heat dissipation mechanism for a dental photo-curing machine. The thermally conductive plate 112 of the thermally conductive assembly 200 in the heat dissipation mechanism is closely attached to the photo-curing lamp 108, so that the heat generated by the photo-curing lamp 108 can be conducted, through the thermally conductive plate 112 and the heat pipe 220 on at least one side of the thermally conductive plate 112, to a part of the shell 101 for forming the main body portion 120, so as to be released, where presence of the heat pipe 220 can greatly increase a speed of heat conduction, thereby achieving quick cooling of a region of the shell 101 located in the vicinity of the photo-curing lamp 108, avoiding scalding the patient, and meanwhile guaranteeing light emitting efficiency and service lifetime of the photo-curing lamp 108.

In other words, the present disclosure can avoid the problem of scalding the patient caused by a too high temperature of a part of the photo-curing operation portion located in the oral cavity of the patient, realize quick cooling of the region of the shell located in the vicinity of the photo-curing lamp, avoid scalding the patient, and meanwhile ensure the light emitting efficiency and the service lifetime of the photo-curing lamp.

Embodiments of the present disclosure further disclose a dental photo-curing machine, including the photo-curing operation portion disclosed in the above embodiments, and thus having all the technical effects of the above photo-curing operation portion, which will not be repeated herein.

In some embodiments, as shown in FIG. 4 and FIG. 5, the present disclosure discloses a dental photo-curing machine, which includes a heat dissipation mechanism and the photo-curing lamp 108.

The heat dissipation mechanism includes a shell 101 and a thermally conductive assembly 200. An inner cavity of the shell 101 includes a lamp mounting end 1101 and a main body portion 120 which communicate with each other. The lamp mounting end 1101 is configured to mount the photo-curing lamp 108 of the dental photo-curing machine. The thermally conductive assembly 200 includes a thermally conductive plate (base plate) 112 and a heat pipe 220 located on at least one side of the thermally conductive plate 112. The thermally conductive plate 112 partially extends into the lamp mounting end 1101, so as to be capable of being closely attached to the photo-curing lamp 108, and the other end of the thermally conductive plate 112 extends into the main body portion 120, so as to conduct heat generated by the photo-curing lamp 108 to a part of the shell 101 for forming the main body portion 120.

In this way, by attaching the thermally conductive plate 112 closely to the photo-curing lamp 108, the heat generated by the photo-curing lamp 108 can be conducted, through the thermally conductive plate 112 and the heat pipe 220 on at least one side of the thermally conductive plate 112, to a part of the shell 101 for forming the main body portion 120, so as to be released, where presence of the heat pipe 220 can greatly increase a speed of heat conduction, thereby achieving quick cooling of a region of the shell 101 located in the vicinity of the photo-curing lamp 108, avoiding scalding the patient, and meanwhile guaranteeing light emitting efficiency and service lifetime of the photo-curing lamp 108.

The heat pipe 220 is an efficient heat conduction element, usually composed of a pipe case, a wick (liquid absorbing core) and an end cover, where an interior of the heat pipe is pumped into a negative-pressure state and filled with a suitable liquid, and the wick is made of a capillary porous material. When one end of the heat pipe 220 is heated, the liquid is rapidly evaporated, and vapor is driven by heat diffusion to flow to the other end and condenses at a cold end to release heat; and the liquid then flows back to an evaporation end under capillary effect along the porous material. This cycle continues until temperatures at two ends of the heat pipe 220 are equal. Therefore, the heat pipe 220 has an extremely high heat conduction speed, and a heat dissipation speed of a lamp holder can be accelerated using the heat pipe 220 as a thermal conductor.

Specifically, the thermally conductive plate 112 is a copper plate, and certainly may also be made of other materials having good thermal conductivity. Two opposite sides of the thermally conductive plate 112 are each provided with the heat pipe 220. In this way, heat can be quickly transferred from the photo-curing lamp 108 to the main body portion 120 through the thermally conductive plate 112 and the heat pipes 220. Certainly, in some embodiments, the heat pipe 220 may be provided only on one side of the thermally conductive plate 112.

The main body portion 120 is filled therein with a heat storage material 110, and the thermally conductive plate 112 and the heat pipe 220 are both wrapped by the heat storage material 110. The heat storage material 110 may be a phase-change heat storage material, for example, a phase-change heat storage material 110 such as phase-change paraffin or phase-change microcapsule, or a mixture of a phase-change material such as phase-change paraffin and a thermally conductive material. In this way, the heat generated by the photo-curing lamp 108 is transferred, through the thermally conductive plate 112 and the heat pipe 220, to the heat storage material 110 in the main body portion 120 to be temporarily stored, and is released outwards through the shell 101 after reaching saturation, thus reducing a heating rate of the shell 101.

Specifically, the thermally conductive plate 112 divides the lamp mounting end 1101 into a mounting cavity 1102 and a thermally insulated cavity 107, where the mounting cavity 1102 is configured to mount the photo-curing lamp 108, the thermally insulated cavity 107 communicates with the main body portion 120, and one side of the thermally conductive plate 112 facing the mounting cavity 1102 is configured to be closely attached to the photo-curing lamp 108. In this way, by forming the thermally insulated cavity 107, a contact area between the thermally conductive plate 112 and the part of the shell 101 for forming the lamp mounting end 1101 can be reduced, and a heat conduction path is extended, thereby slowing down a speed at which the heat is transferred from the photo-curing lamp 108 to the shell 101, and further preventing a too high temperature of the part of the metal housing for forming the lamp mounting end 1101.

More specifically, the lamp mounting end 1101 has a mounting hole 113 located between the thermally insulated cavity 107 and the mounting cavity 1102, where an inner diameter of the mounting hole 113 is smaller than an inner diameter of the thermally insulated cavity 107 and an inner diameter of the mounting cavity 1102. The thermally conductive plate 112 has a mounting protrusion 211, and the mounting protrusion 211 fits in the mounting hole 113, thereby implementing mounting of the thermally conductive plate 112 and the shell 101, where one side of the mounting protrusion 211 facing the mounting cavity 1102 is configured to be closely attached to the photo-curing lamp 108, so that the heat generated by the photo-curing lamp 108 can be directly conducted to the thermally conductive plate 112.

In addition, a thermally insulated pad 111 is closely attached to a side of the thermally conductive plate 112 facing back to the mounting cavity 1102, the thermally insulated pad 111 is spaced apart from a region of the inner wall of the thermally insulated cavity 107 away from the mounting cavity 1102, the heat pipe 220 located on a side of the thermally conductive plate 112 facing back to the photo-curing lamp 108 is partially located between the thermally insulated pad 111 and the thermally conductive plate 112, in this way, the thermally insulated pad 111 can further prevent the heat from being transferred to the part of the shell 101 for forming the lamp mounting end 1101, so as to better prevent a too high local temperature of the shell 101.

It should be noted that in the present disclosure, connection of the thermally conductive plate 112 with the heat pipe 220, the photo-curing lamp 108 and the shell 101, and connection between the heat pipe 220 and the thermally insulated pad 111 are not specifically limited, as long as fixation, for example, adhesion, etc., of the photo-curing lamp 108, the thermally conductive plate 112, the heat pipe 220 and the thermally insulated pad 111 can be realized in the shell 101.

In addition, the dental photo-curing machine further includes a lens 103, where the lens 103 is embedded at the lamp mounting end 1101 and is corresponding to the light emergent side of the photo-curing lamp 108, and the lens 103 enables light emitted by the photo-curing lamp 108 to be gathered, so that use effect is better.

To sum up, for the heat dissipation mechanism and the dental photo-curing machine disclosed in the embodiments of the present disclosure, by attaching the thermally conductive plate 112 closely to the photo-curing lamp 108, the heat generated by the photo-curing lamp 108 can be conducted, through the thermally conductive plate 112 and the heat pipe 220 on at least one side of the thermally conductive plate 112, to the part of the shell 101 for forming the main body portion 120, so as to be released, where the presence of the heat pipe 220 can greatly increase a speed of heat conduction, thereby achieving quick cooling of the region of the shell 101 located in the vicinity of the photo-curing lamp 108, avoiding scalding the patient, and meanwhile guaranteeing light emitting efficiency and service lifetime of the photo-curing lamp 108.

Finally, it should be noted that the various embodiments above are merely used for illustrating the technical solutions of the present disclosure, rather than limiting the present disclosure; although the detailed description is made to the present disclosure with reference to various preceding embodiments, those ordinarily skilled in the art should understand that they still could modify the technical solutions described in various preceding examples, or make equivalent substitutions to some or all of the technical features therein; and these modifications or substitutions do not make the corresponding technical solutions essentially depart from the scope of the technical solutions of various embodiments of the present disclosure.

What is claimed is:

1. A photo-curing operation portion, comprising:
a shell, having a first end as a lamp mounting end, and a second end as a host mounting end configured for being mounted to a host;
a photo-curing lamp, provided at the lamp mounting end, wherein the shell is provided with a mounting cavity configured to arrange at least one wire of the photo-curing lamp; and
a thermally insulated structure, wherein the thermally insulated structure is provided between a thermally conductive plate of the photo-curing lamp and an inner wall of the shell.

2. The photo-curing operation portion according to claim 1, wherein the thermally insulated structure comprises a thermally insulated cavity provided between the thermally conductive plate of the photo-curing lamp and the inner wall of the shell; and/or
the thermally insulated structure comprises a thermally insulated pad provided on the thermally conductive plate of the photo-curing lamp.

3. The photo-curing operation portion according to claim 2, further comprising a thermally conductive wrapping provided between the thermally insulated pad and the thermally conductive plate, wherein the thermally conductive wrapping extends into the mounting cavity.

4. The photo-curing operation portion according to claim 3, wherein a part of the thermally conductive wrapping located in the mounting cavity wraps an outer side of the at least one wire.

5. The photo-curing operation portion according to claim 3, wherein a heat storage material configured for absorbing heat of the thermally conductive wrapping is filled in the mounting cavity.

6. The photo-curing operation portion according to claim 5, wherein the thermally conductive wrapping passes through the heat storage material.

7. The photo-curing operation portion according to claim 5, wherein the heat storage material is a phase-change heat storage material; and/or the thermally conductive wrapping is made of graphene or metal.

8. The photo-curing operation portion according to claim 7, wherein the heat storage material is phase-change paraffin or phase-change microcapsule, and in the mounting cavity, thermally conductive adhesive layers are provided at two sides of the heat storage material, a heat storage cavity is formed between the thermally conductive adhesive layers, and the heat storage material is located in the heat storage cavity; or
the heat storage material is a heat storage gel.

9. The photo-curing operation portion according to claim 1, wherein the lamp mounting end is provided with a light outlet, the photo-curing lamp is provided in a cavity of the lamp mounting end, a light emitting portion of the photo-curing lamp faces the light outlet, and a lens is fixed at the light outlet by a locking element.

10. The photo-curing operation portion according to claim 1, further comprising a heat dissipation mechanism, wherein the heat dissipation mechanism comprises the shell and a thermally conductive assembly, an inner cavity of the shell comprises the lamp mounting end and a main body portion communicating with each other, the lamp mounting end is configured to mount the photo-curing lamp; the thermally conductive assembly comprises the thermally conductive plate and a heat pipe on at least one side of the thermally conductive plate, the thermally conductive plate partially extends into the lamp mounting end, so as to be capable of being closely attached to the photo-curing lamp, and the other end of the thermally conductive plate extends into the main body portion, so as to conduct heat generated by the photo-curing lamp to a part of the shell for forming the main body portion.

11. The photo-curing operation portion according to claim 10, wherein the thermally conductive plate is a copper plate, and two opposite sides of the thermally conductive plate are each provided with the heat pipe.

12. The photo-curing operation portion according to claim 10, wherein the main body portion is filled therein with a heat storage material, and the thermally conductive plate and the heat pipe are both wrapped by the heat storage material.

13. The photo-curing operation portion according to claim 12, wherein the heat storage material comprises a phase-change material.

14. The photo-curing operation portion according to claim 10, wherein the thermally conductive plate divides the lamp mounting end into a mounting cavity and a thermally insulated cavity, wherein the mounting cavity is configured to mount the photo-curing lamp, the thermally insulated cavity communicates with the main body portion, and one side of the thermally conductive plate facing the mounting cavity is closely attached to the photo-curing lamp.

15. The photo-curing operation portion according to claim 14, wherein the lamp mounting end has a mounting hole located between the mounting cavity and the thermally insulated cavity, and the thermally conductive plate has a mounting protrusion, wherein the mounting protrusion fits in the mounting hole, and one side of the mounting protrusion facing the mounting cavity is closely attached to the photo-curing lamp.

16. The photo-curing operation portion according to claim 14, wherein a thermally insulated pad is closely attached to a side of the thermally conductive plate facing back to the mounting cavity, and the thermally insulated pad is spaced apart from a region of an inner wall of the thermally insulated cavity away from the mounting cavity.

17. The photo-curing operation portion according to claim 16, wherein the heat pipe is provided between the thermally insulated pad and the thermally conductive plate.

18. The photo-curing operation portion according to claim 10, further comprising a lens, wherein the lens is embedded at the lamp mounting end and is corresponding to a light emergent side of the photo-curing lamp.

19. A dental photo-curing machine, comprising the photo-curing operation portion according to claim 1.
